(19) United States
(12) Patent Application Publication
(10) Pub. No.: US 2010/0055417 A1
(43) Pub. Date: Mar. 4, 2010

(54) DECORATIVE FILM AND DEVICE HOUSING USING THE SAME

(75) Inventors: GANG HUANG, Shenzhen City (CN); YAN-MIN WANG, Shenzhen City (CN); QIANG WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/509,026

(22) Filed: Jul. 24, 2009

(30) Foreign Application Priority Data
Aug. 28, 2008 (CN) 200810304260.2

(51) Int. Cl. B32B 3/10

(52) U.S. Cl. 428/195.1

(57) ABSTRACT

A decorative film comprises a first film layer, a second film layer and a soft layer. The soft layer is laminated between the first film layer and the second film layer, providing a tactile sensation during use.

### BACKGROUND

1. Technical Field

The exemplary disclosure generally relates to decorative films, and particularly to films used in In-Mold Labeling (IML), and device housings using the films.

2. Description of Related Art

Portable electronic devices (such as mobile telephones and electronic notebooks) are in widespread use. The external appearance of the housing of the portable electronic device has become a key factor for attracting consumers.

The external appearance of the housing can usually be made by In-Mold Labeling (IML). A film bearing predetermined patterns, text, or pictures is placed in the die and directly molded to a housing molded within the die. The film typically used in In-Mold Labeling wears well, and has a leather dope formed thereon for improving tactile effect of the housing. However, the leather dope is easily abraded, decreasing the desired effect.

Thus, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the exemplary film and housing using the film. Moreover, in the drawings like reference numerals designate corresponding parts throughout the several views. Wherever possible, the same reference numbers are used throughout the drawings to refer to the same or like elements of an embodiment.

FIG. 1 is a cross-section of an exemplary embodiment of a film used in a housing, the housing including a substrate and the film formed on the substrate.

FIG. 2 is a partially enlarged view of a housing using a decorative film, such as, for example, that of FIG. 1.

FIG. 3 is an illustrated view of a method of manufacturing the housing shown in FIG. 2.

### DETAILED DESCRIPTION

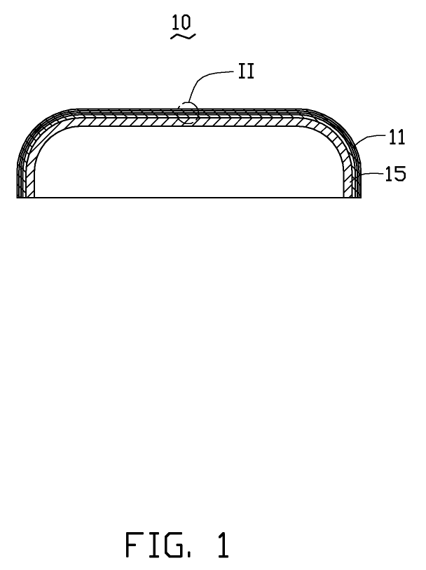

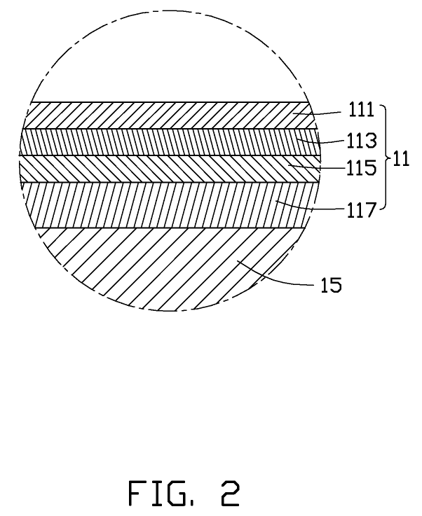

Referring to FIGS. 1 and 2, an exemplary embodiment of a film 11 can be used by a housing 10 including a substrate 15, with the film 11 formed thereon. The film 11 includes a transparent first film layer 111, a transparent soft layer 113, and a transparent second film layer 115. The soft layer 113 is laminated between the first film layer 111 and the second film layer 115. The film 11 further includes a decorative layer 117 formed on the second film layer 115 opposite to the soft layer 113.

Material for the first film layer 111 can be a resin sheet of a single body or a copolymer of a PP (polypropylene), PA (polyamide), PC (polycarbonate), PMMA (polymethyl methacrylate) or other. The soft layer 113 may be silica gel. The second film layer 115 may be the same material as the first film layer 111.

The decorative layer 117 may be laminated over the entire or partial surface of the first film layer 111. The decorative layer 117 is normally formed as a print layer. As a material for the print layer, it is common to use a resin such a polyvinyl based resin, a polyamide based resin, a polyester based resin, an acrylic resin, a polyurethane based resin, apolyvinyl acetal based resin, a cellulose ester based resin, or an alkyd resin as a binder and employ a coloring ink that contains a pigment or dye of an appropriate color as a coloring agent. For formation of the print layer, it is preferred to use an ordinary printing method such as gravure, screen, or offset printing method. In particular, offset printing and the gravure printing are appropriate for carrying out multicolor printing and half-toning. Moreover, in the case of a single color, it is acceptable to adopt a coating method such as the gravure coating method, the roll coating method, or the comma coating method.

The substrate 15 is integrally molded on the second film layer 115. The substrate 15 is made of a thermoplastic material such as PE (polyethylene), PC (polycarbonate), ABS (acrylonitrile bivinyl styrene), PMMA (polymethyl methacrylate), or any combination thereof.

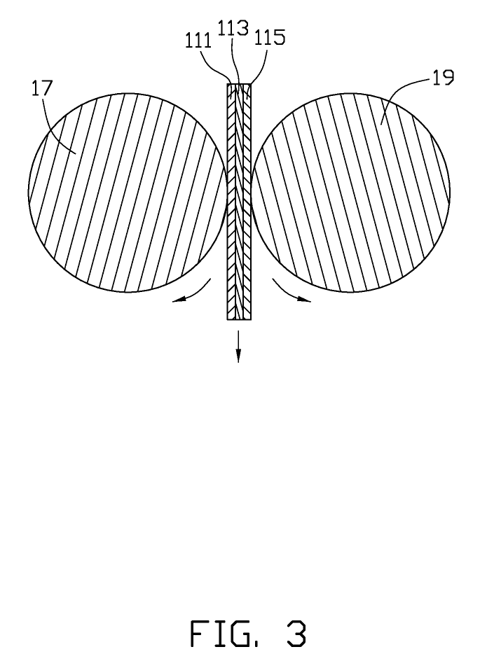

Referring to FIG. 3, a method of fabricating the film 11 employing the disclosed first film layer 111, the soft layer 113 and the second film layer 115, using a transfer method is shown. One side of the soft layer 113 is pressed against the surface of the first film layer 111 and another side of the soft layer 113 is pressed against the surface of the second film 11, whereby soft layer 113 is laminated between the first film layer 111 and the second film layer 115. A transfer machine, such as a roll transfer machine equipped with heat-proof rubber rollers 17 and 19, applies heat and pressure to the first film layer 111, the second film layer 115, and the soft layer 113 via the rollers 17 and 19 set at about 80 to 260° C. at a pressure of about 400 to 2000 Pa. Accordingly, the first film layer 111, the soft layer 113, and the second film layer 115 are integrally bonded. Finally, the decorative layer 117 is formed on the other surface of the second film layer 115 opposite to the soft layer 113 using an ordinary printing method such as gravure, screen printing, or offset printing method, such that film 11 is yielded.

A method of fabricating the housing 10 employing the disclosed the film 11, using injecting molding will now be described. Film 11 is disposed into the molding metal mold constructed of a movable die and a fixed die. After the metal mold is closed, a melted thermoplastic material is injected from the gate into the metal mold to form the substrate 15, and the substrate 15 bonds with the decorative layer 117, thus yielding the housing 10.

Because the soft layer 113 is laminated between the first film layer 111 and the second film layer 115, and the first film layer 115 is thin, about 0.2 mm, tactile sensation occurs when the film 11 is touched. Additionally, the soft layer 113, being laminated between the first film layer 111 and the second film layer 115, is protected from abrasion during use.

It is to be understood, however, that even though numerous characteristics and advantages of the exemplary disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A decorative film comprising:
a first film layer;
a second film layer; and
a soft layer, the soft layer laminated between the first film layer and the second film layer.

2. The decorative film of claim 1, wherein the first film layer is made of a resin sheet of a single body or a copolymer of polypropylene, polyamide, polycarbonate, polymethyl methacrylate.

3. The decorative film of claim 1, wherein the second film layer is made of a resin sheet of a single body or a copolymer of a polypropylene, polyamide, polycarbonate, or polymethyl methacrylate.

4. The decorative film of claim 1, wherein the soft layer is made of silica gel.

5. The decorative film of claim 1, wherein the film further includes a decorative layer formed on the second film layer opposite to the soft layer.

6. A housing comprising:
a substrate; and
a decorative film comprising:
a first film layer;
a second film layer integrally molded with the substrate; and
a soft layer, laminated between the first film layer and the second film layer.

7. The housing of claim 6, wherein the first film layer is made of a resin sheet of a single body or a copolymer of a polypropylene, polyamide, polycarbonate, or polymethyl methacrylate.

8. The housing of claim 6, wherein the second film layer is made of a resin sheet of a single body or a polypropylene, polyamide, polycarbonate, or polymethyl methacrylate.

9. The housing of claim 6, wherein the soft layer is made of silica gel.

10. The housing of claim 6, wherein the substrate is made of thermoplastic material such as polyethylene, polycarbonate, acrylonitrile bivinyl styrene, polymethyl methacrylate, or any combination thereof.
